(19) United States
(12) Patent Application Publication
(10) Pub. No.: US 2016/0180461 A1
(43) Pub. Date: Jun. 23, 2016

(54) SYSTEMS AND METHODS FOR MANAGING SECURITY TRADES

(71) Applicant: HazelTree Fund Services, Inc., New York, NY (US)

(72) Inventor: SANDEEP RAWAL, Wyckoff, NJ (US)

(73) Assignee: HazelTree Fund Services, Inc., New York, NY (US)

(21) Appl. No.: 14/638,025

(22) Filed: Mar. 4, 2015

Related U.S. Application Data
(60) Provisional application No. 62/093,343, filed on Dec. 17, 2014.
(60) Provisional application No. 62/093,343, filed on Dec. 17, 2014.

(51) Int. Cl. G06Q 40/04

(52) U.S. Cl. CPC G06Q 40/04

(57) ABSTRACT

Systems and methods are provided for managing the trading of securities by providing systems and methods of securities, account, and position reconciliation, as well as tax lot management. In particular, data such as positions data, trade data, tax lot data can maintained in one or more data tables and subsequently reconciled, updated, and reported using agnostic data storage and access mechanisms that allow for up-to-date and accurate data monitoring, gathering, manipulation, and reporting.

### CROSS-REFERENCE TO RELATED APPLICATIONS

This application claims the benefit of U.S. Provisional Application No. 61/948,397 filed Mar. 5, 2014 and U.S. Provisional Application No. 62/093,343 filed Dec. 17, 2014, which are hereby incorporated herein by reference in their entirety.

### TECHNICAL FIELD

Various embodiments of the technology disclosed herein generally relate to computer systems, and more particularly, various embodiments relate to systems and methods for managing the trading of securities.

### DESCRIPTION OF THE RELATED ART

Investment accounts hold different securities such as stocks, bonds, mutual funds, and the like for security holders, namely, investors. Individuals, trusts, corporations, and other investors utilize their investment accounts to achieve long and short term savings goals and as an aid in tax planning. The holdings of an investment account may be managed by an investor or an entity managing or otherwise associated with the investment account, such as a brokerage firm, an investment management firm, etc. Based on an investor's preference, an investment account may be associated with an asset allocation model that reflects an investment style (e.g., aggressive, growth, value, income) and a mix of security assets (e.g., stocks, bonds, cash) in conformity with the investment style. Trading securities may have tax implications and different security trades are subject to different tax rates. Precise bookkeeping is therefore necessary but prone to errors when conducted in accordance with conventional bookkeeping/accounting systems and methods.

### BRIEF SUMMARY OF EMBODIMENTS

According to various embodiments, systems and methods for securities management are provided.

In accordance with one embodiment, a computer-implemented method, comprises obtaining a first set of trade data records at a first time point, each trade data record of the first set of trade data records comprising a first security and a first set of trading quantities associated with the first security. The method further comprises storing the first security as a set of trade data table entries in a data store, the data store comprising the trade data table and a tax lot data table. Further still, the method comprises determining a first set of tax lots, from the tax lot data table, associated with the first security, and storing each trading quantity of the first set of trading quantities in a corresponding trade data table entry.

In accordance with another embodiment, a system comprises a processor, and a memory storing instructions that, when executed by the processor, cause the system to perform: obtaining a first set of trade data records at a first time point, each trade data record of the first set of trade data records comprising a first security and a first set of trading quantities associated with the first security; storing the first security as a set of trade data table entries in a data store, the data store comprising the trade data table and a tax lot data table; determining a first set of tax lots, from the tax lot data table, associated with the first security; and storing each trading quantity of the first set of trading quantities in a corresponding trade data table entry.

In accordance with yet another embodiment, a non-transitory computer-readable storage medium including instructions that, when executed by at least one processor of a computing system, cause the computing system to perform: obtaining a first set of trade data records at a first time point, each trade data record of the first set of trade data records comprising a first security and a first set of trading quantities associated with the first security; storing the first security as a set of trade data table entries in a data store, the data store comprising the trade data table and a tax lot data table; determining a first set of tax lots, from the tax lot data table, associated with the first security; and storing each trading quantity of the first set of trading quantities in a corresponding trade data table entry.

Other features and aspects of the systems and methods described herein will become apparent from the following detailed description, taken in conjunction with the accompanying drawings, which illustrate, by way of example, the features in accordance with embodiments of the systems and methods described herein. The summary is not intended to limit the scope of the systems and methods described herein, which is defined solely by the claims attached hereto.

### BRIEF DESCRIPTION OF THE DRAWINGS

The present invention(s), in accordance with one or more various embodiments, are described in detail with reference to the following figures. The drawings are provided for purposes of illustration only and merely depict typical or example embodiments of the systems and methods described herein. These drawings are provided to facilitate the reader's understanding of the systems and methods and shall not be considered limiting of the breadth, scope, or applicability of the systems and methods. It should be noted that for clarity and ease of illustration these drawings are not necessarily made to scale.

FIG. 1 illustrates an example securities management system in which an agnostic data storage mechanism can be utilized in accordance with various embodiments of the technology disclosed herein.

FIG. 2 illustrates an example system architecture of data sources and modules for managing securities in accordance with various embodiments of the technology disclosed herein.

FIG. 3A is a flow chart of example operations performed for managing securities in accordance with various embodiments of the technology disclosed herein.

FIG. 3B is a flow chart of example operations performed for managing tax lot data in the context of securities management in accordance with various embodiments of the technology disclosed herein.

FIG. 4 illustrates an example data file that can be utilized in the agnostic data storage mechanism in accordance with various embodiments of the technology disclosed herein.

FIG. 5 is a flow chart of example operations performed for agnostic data storage in accordance with one embodiment of the technology disclosed herein.

FIG. 6 illustrates example data structures for agnostic data storage in accordance with various embodiments of the technology disclosed herein.

FIG. 7 illustrates data tables for agnostic data storage in accordance with various embodiments of the technology disclosed herein.

FIG. 8 is a flow chart of example operations performed for agnostic data storage in accordance with another embodiment of the technology disclosed herein.

FIG. 9 is a diagram illustrating an example computing module that may be used in implementing various features of embodiments of the systems and methods described herein.

The figures are not intended to be exhaustive or to limit the systems and methods described herein to the precise form disclosed. It should be understood that the systems and methods can be practiced with modification and alteration, and that the systems and methods be limited only by the claims and the equivalents thereof.

### DETAILED DESCRIPTION OF THE EMBODIMENTS

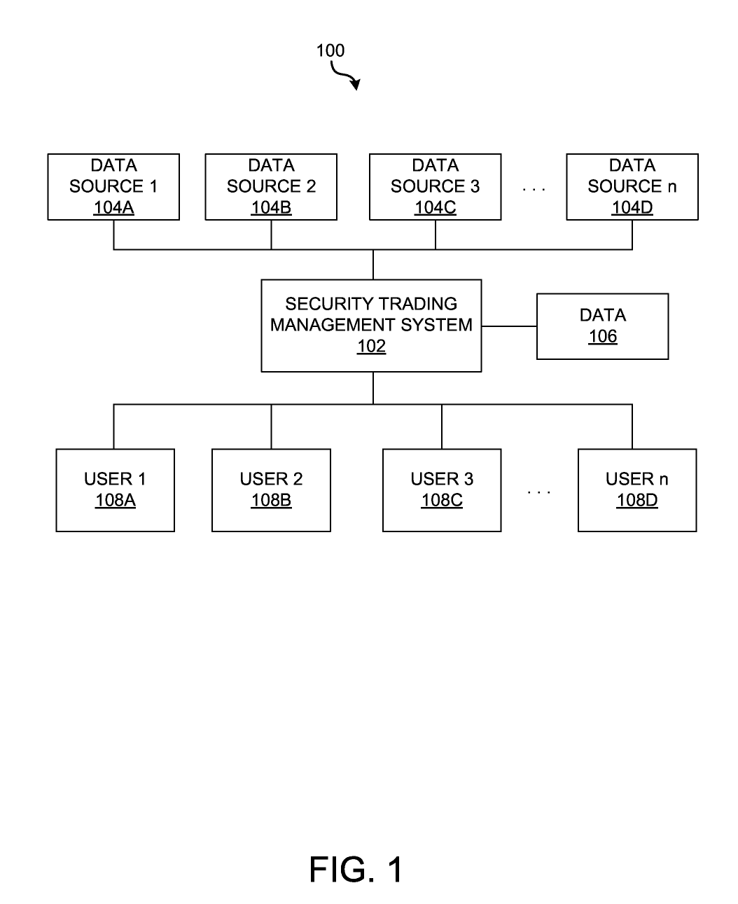

Before describing various embodiments in detail, it may be useful to describe an example environment with which some embodiments can be used. FIG. 1 is a diagram illustrating a simplified environment 100 in which an exemplary security trading management system 102 operates in accordance with an embodiment of the systems and methods described herein. In this example environment, the security trading management system 102 is coupled to at least one data source from data sources 104 A-D, and at least one user from users 108 A-D. A user may be a human, a module, a computer, computer program, or some other entity. The security trading management system 102 may be configured to receive data 106 from at least one data source. Data 106 may be received in files of different formats (e.g., Portable Document Format (PDF) or an Excel® spreadsheet). Data 106 may include trade data, tax lot data, position data or other data related to security trades.

The security trading management system 102 may be configured to process and store data 106. In some embodiments, the security trading management system 102 may receive and process data files from a data source 102. The data 106 received may be related to numerous investment accounts owned by one or more users from the users 108 A-D. The security trading management system 102 may normalize data received in different formats, identify trade data, identify tax lot data, identify position data, store the data and maintain different data tables such as trade table, tax lot table by using the data received accordingly. Further, a user 108 may access, complete, modify, validate, and submit data 106 through the security trading management system 102 manually. Via a User Interface (UI) of the security trading management system 102, a user 108 may also approve or deny a trade, review tax lot information, and/or review trade quantity through the security trading management system 102.

From time-to-time, the systems and methods described herein are described herein in terms of this example environment illustrated in FIG. 1. A detailed description in terms of these environments is provided to allow the various features and embodiments of the systems and methods described herein to be portrayed in the context of an exemplary application. After reading this description, it will become apparent to one of ordinary skill in the art how the systems and methods described herein can be implemented in different and alternative environments.

Various embodiments are directed to managing the trading of securities by providing systems and methods of securities, account, and position reconciliation. In particular, data such as positions data, trade data, tax lot data can maintained in one or more data tables and subsequently reconciled, updated, and reported.

Securities can refer to any financial asset (e.g., bank deposit, bond, stock) that can be traded (bought and/or sold) in a secondary market. There are several broad categories of securities, i.e., debt securities (e.g., banknotes, bonds, and debentures), equity securities (e.g., common stocks), and derivative securities (e.g., forwards, futures, options, and swaps). The term secondary market can refer to the market in which securities can be sold by and transferred from one investor or speculator to another without, e.g., an issuing company's involvement. This is in contrast to the primary market in which securities are created.

In the case of primary issuances of securities or financial instruments, investors may purchase such securities or financial instruments directly from issuers. Issuers in this instance may be corporations issuing shares in an initial public offering (IPO), private placement, or directly from the federal government in the case of treasuries. After an initial issuance, investors can purchase securities from other investors in the secondary market.

The secondary market can vary from loans to stocks, from fragmented to centralized, and from illiquid to very liquid. Major stock exchanges, such as the New York Stock Exchange (NYSE), the London Stock Exchange and Nasdaq are commonly-known examples of liquid secondary markets. Such stock exchanges may provide a centralized, liquid secondary market for investors who own stocks that trade on those exchanges. Most bonds and structured products trade “over the counter,” or by engaging in trading through one's broker-dealer.

As alluded to above, securities can be categorized into the following three types. Debt securities allow an investor to provide loans, referred to as bonds, to a company or even a country. Ratings companies, like Standard & Poor's, Moody's, and Fitch's evaluate how likely it is the bond will be repaid. Corporate bonds are loans to a company. If the bonds are to a country, they are known as sovereign debt. Bonds issued by the U.S. government are Treasury bonds. Equity securities allow ownership of shares of a corporation, and stocks of a company can be directly purchased, by buying shares of a mutual fund, which invests in the stocks for a consumer/investor, or by participating in IPO and buying from investment banks, like Goldman Sachs or Morgan Stanley. Derivative securities can refer to some form of agreement to buy or sell an asset or item at a fixed price on or before some predetermined date. For example, stock options allow an investor to trade in stocks without actually buying them upfront.

For securities firms, custodian banks and service providers, reconciliation can include various accounting and data clarification operations that are undertaken to help prevent confusion and loss caused by the complications of securities transactions. For example, reconciliation may involve the confirmation of the balance of securities and cash that will fund a financial transaction, e.g., reconciliation can be performed between the books and records of an investment management firm and those of the firm's custodian bank, which holds the securities and cash associated with a securities transaction. The investment management firm and the custodian bank should be in agreement that the instructions governing a particular transaction have been executed according to the wishes of the investment management firm's client, which includes making certain the securities and cash are available to complete the transaction.

Reconciling securities transactions may also entail each entity comparing the data each may have regarding the securities transaction. This can involve significant effort on the part of either or both entities to capture and match data, establish an exceptions list, implement exception management, and provide updates on whether or not the books and records have been reconciled.

Industry concerns over improved risk controls have been growing and there is more demand for increased transparency into the reconciliation process. Some of the key pieces of information that have to be reconciled are the actual trade data, settlement information, security identification, the type of transaction, the number of shares and the total amount for the transaction.

Still other information that should be considered in securities transactions involves tax lots. That is, each time a security is purchased, the new position necessitates a distinct and separate tax lot even if an account already owns shares of the same security. A tax lot can refer to a record of a transaction and its tax implications, including the purchase date, the number of shares purchased, and the cost of the shares.

A tax lot identification method is used to determine which tax lots are to be sold when an investor has a position that can be made up of multiple purchases on different dates at differing prices, where a trade to sell only a portion of the position is entered. Tax lot ID methods can include the following: First-in, first-out (FIFO); Last-in, first-out (LIFO); Highest cost; Lowest cost; Specific lot; Average Cost; and Tax Efficient Loss Harvester (Loss Harvester). Use of different tax lot ID methods can impact the computation of capital gains and/or losses when, e.g., shares are sold.

Many entities still rely on manual reconciliation techniques due the diversity of data sources from which data must be stored and/or retrieved. Moreover, many entities still rely on non-automated formats such as paper-based system. Further still, and as alluded to above, the different tax implications that may apply to various securities actions, require precise bookkeeping that may often be prone to errors when conducted in accordance with conventional bookkeeping/accounting systems and methods.

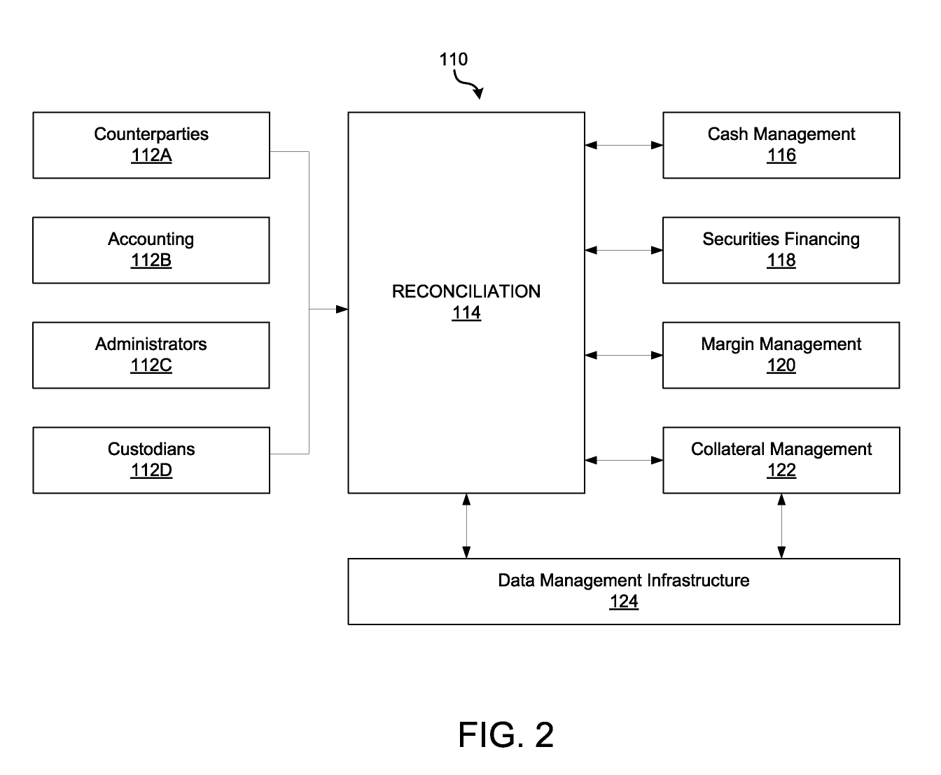

FIG. 2 illustrates a schematic diagram illustrating various aspects of a reconciliation system 110 in accordance with various embodiments of the technology disclosed herein. Reconciliation system 110 may include a plurality of data sources, as discussed previously. Such data sources may include counterparties 112A, one or more accounting entities 112B, one or more administrators 112C, and one or more custodians 112D. Data regarding one or more of securities-related data such as positions data, securities values, account balances, trade information, etc. can originate or may be obtained from one of more these data sources 112A-112D.

Reconciliation system 110 may further include a reconciliation module 114, which is communicatively connected to data sources including counterparties 112A, one or more accounting entities 112B, one or more administrators 112C, and one or more custodians 112D. Reconciliation system 110 is also communicatively connected to various modules including a cash management module 116, a securities financing module 118, a margin management module 120, and a collateral management module 122. Furthermore, a data management infrastructure 124 through which various information and data exchanged between reconciliation system 110 and the aforementioned cash management module, 116, securities financing module 118, margin management module 120, and collateral management module 122 is managed.

Data management infrastructure 124 may comprise one or more systems for mapping and managing data and information from the aforementioned modules. Moreover, data management infrastructure 124 may allow for data analysis, optimization, fund transfers, and reporting. For example, data management infrastructure 124 may integrate and normalize data feeds from any of the aforementioned sources/modules, provide quality checks, and provide an audit trail, while also integrating with any internal (investors') bookkeeping systems and/or records. One example of a data management infrastructure 124 is described in U.S. patent application Ser. No. 13/686,686, assigned to the assignee of the present disclosure, and which is incorporated herein by reference in its entirety.

Reconciliation module 114 provides automated transaction, position, and cash level reconciliations across any relevant counterparties. For example, cash balances may be linked with the appropriate transaction details from any relevant data source, e.g., one of data sources 112A-D, reducing the time consumed for reconciliation compared to manual methods, as well as reducing or altogether eliminating errors associated with manual methods of reconciliation. Additionally, reconciliation module 114 can manage data inputs, produce various user interfaces (UIs) and/or output reports, where the reports can encompass high level or low level detail, as desired. Further still, data can be viewed and analyzed from differing perspectives.

Cash management module 116 can provide information regarding an investor's cash balances, e.g., debits and credits, that may be held by brokerage entities, custodian banks, and other counterparties. Moreover, rates across counterparties can be accessed and analyzed to optimize cash positions, e.g., by transferring funds across counterparties. Further still, balances and rates can be computed, while cash transfers, foreign exchange trades, and expenses can be automatically processed utilizing cash management module 116.

Securities financing module 118 provides a user with various securities-related information, including but not limited to: current borrowing rates; lending rates; indicate rates; available inventory; current transactions; and rebates. Accordingly, securities financing module 118 allows an investor to find securities in which investment may be desired, applicable rates. Additionally, securities financing module 118 can provide projected revenue options and a mechanism for managing these options, as well as managing an investor's positions across brokers. Monitoring and reporting can be performed by securities financing module 118 in an aggregate fashion across counterparties, portfolio, individual traders and position. Securities financing module 118 can also interact with data sources, such as one or more accounting entities 112B to allow for reconciliation via reconciliation module 114.

Margin can refer to purchasing, e.g., stock, using monies borrowed from a broker and using investments as collateral. Margin analytics module 120 provides aggregate monitoring of an investor's margin exposures at varying levels, e.g., broker level, security level. If desired, margin analytics module 120 can provide user-determined filtering to provide margin information at the fund, region, sector, etc. levels. Similar to the other modules described herein, margin analytics module 120 can interact with reconciliation module 114 to maintain accurate bookkeeping and reconciliation with regard to positions, rates, prices, margin requirements, quantity, and market value of investments.

As described above, investments may be used as collateral. Collateral management module 122 provides an investor with collateral information across relevant entities/systems. For example, collateral management module 122 can interact with one or more accounting systems 112B or one or more administrators 112C to access relevant information associated with collateral management across positions. Collateral management module 122 can process information and/or data inputs that can involve Credit Support Annex (CSA) and Global Master Repurchase Agreement (GMRA) documents as well as any other supporting documentation using the aforementioned data management infrastructure 124. Collateral management module 122 can also communicate with one or more counterparties 112A to allow for accurate reconciliation in conjunction with reconciliation module 114.

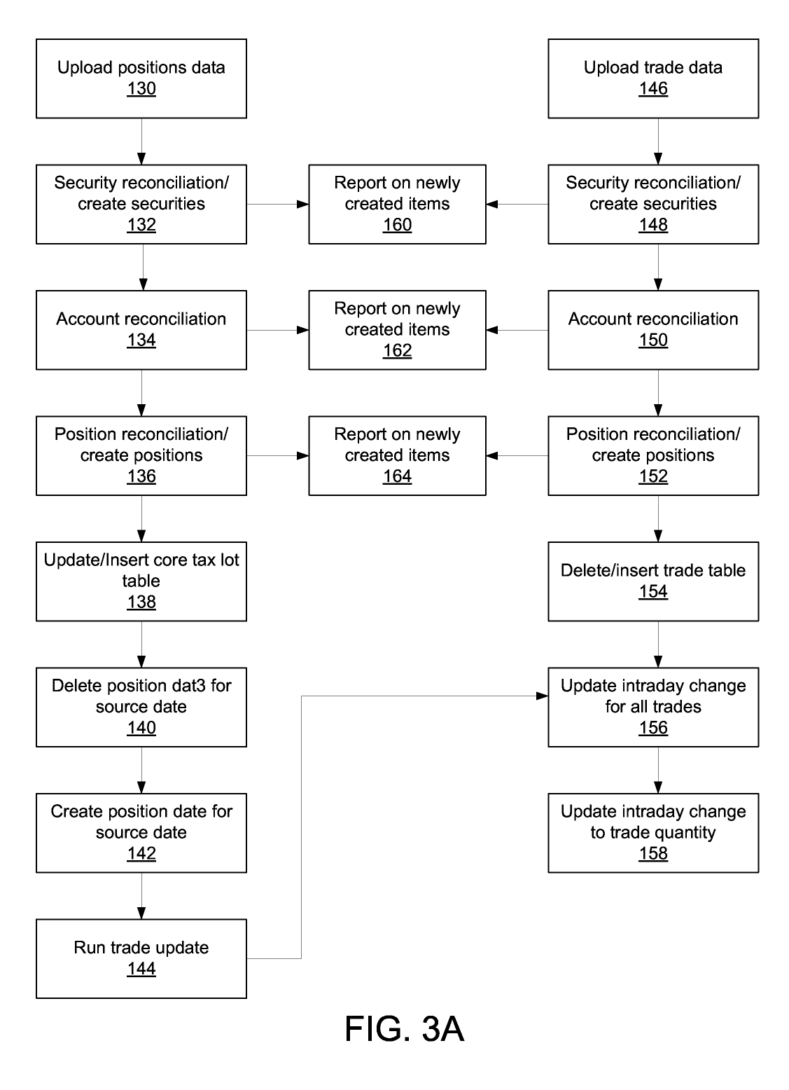

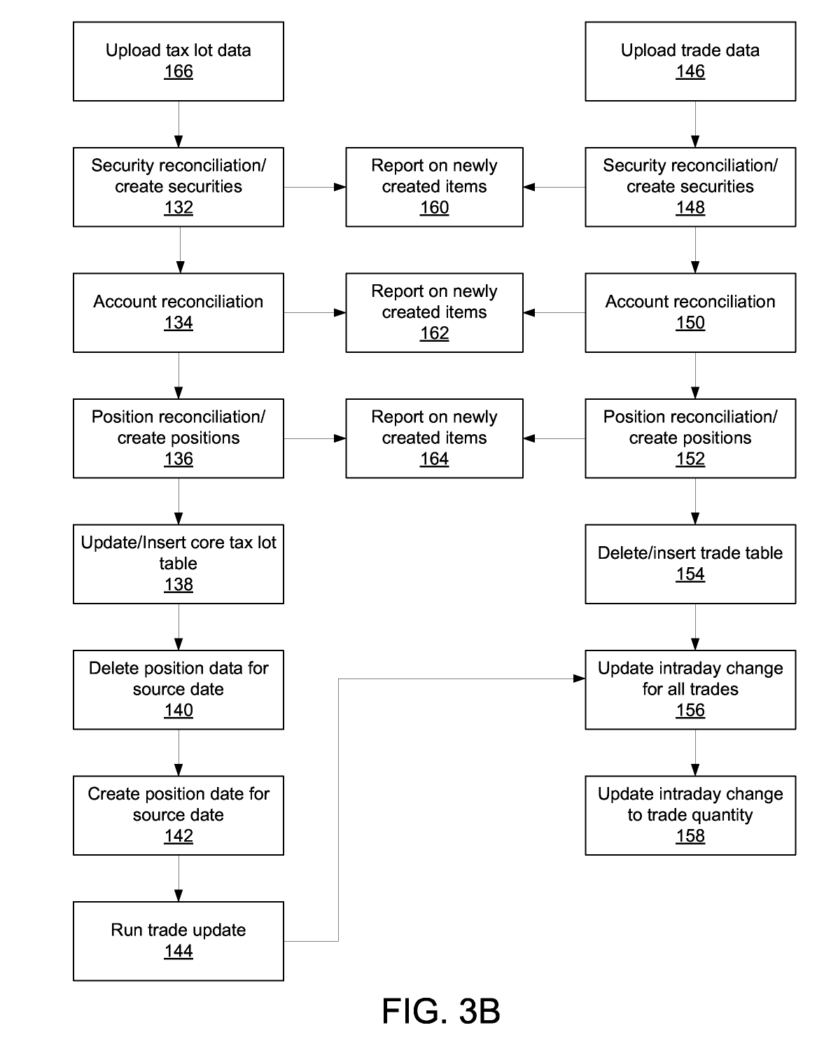

FIG. 3A is a flow chart illustrating an exemplary process for managing security trades in accordance with an embodiment of the systems and methods described herein. At operation 130, positions data can be received and uploaded into a corresponding data table. Position data can include the amount of a particular security owned or borrowed, information detailing the security, etc. by account/fund, for example. At operation 132, security reconciliation, as described above can be performed, as well as the creation of any securities. At operation 134, account reconciliation can be performed by ensuring cash balances are properly linked with the appropriate transaction details. At operation 136, position reconciliation and any positions can be created in accordance with any securities transactions. At operation 138, relevant core tax lot data can be input or updated in accordance with any relevant transactions that have taken place. At operation 140, any outdated position date is deleted for the relevant source date. At operation 142, any new position date is created for the relevant source date associated with uploaded positions data (from operation 130). At operation 144, a trade update can be run.

At operation 146, any applicable trade data records are received and uploaded. A trade data record can include relevant securities information, the quantity, direction, price of the trade, etc. For example, a trade data record may indicate the quantity of a security at a position (e.g., either long or short) traded by an account at a time. At a particular time, an account may trade many securities. At a particular time, multiple accounts may trade, in various quantities, a security at a particular position. An account may also trade a security that corresponds to different positions at a time point. The trade data records may be received regularly at a predetermined time interval (e.g., every two minutes, every twenty minutes). The trade data records may be received every time when a user trades a security. At operation 148, a security is recognized from the trade data records received at operation 146, and similar to operation 132, security reconciliation/creation can be performed. At operations 150 and 152, account reconciliation and position reconciliation/position creation can also be performed, respectively. It should be noted that reconciliation can be performed in accordance with any desired timing, e.g., daily, weekly, monthly, etc. in order to ensure up-to-date record-keeping.

At operation 154, the relevant trade data that was uploaded in operation 146 can be deleted or inserted into a trade table, depending upon whether the trade involved a purchase or sale of one or more securities. At operation 156, any intraday changes can be updated for all relevant trades within that day. At operation 158, the trade quantity is also updated to reflect the specifics of the uploaded trade data.

It should be noted that running the trade update at operation 144 can prompt or initiate the updating of the intraday changes for trades at operation 156. It should also be noted that at operations 160, 162, and 164, any newly created items regarding the creation or reconciliation of securities, account reconciliation, and/or the creation or reconciliation of positions is reported.

FIG. 3B is a flow chart illustrating an exemplary process for managing security trades in accordance with an embodiment of the systems and methods described herein with a focus on tax lot data. That is and again, each time a security is purchased, the new position necessitates a distinct and separate tax lot even if an account already owns shares of the same security. A tax lot can refer to a record of a transaction and its tax implications, including the purchase date, the number of shares purchased, and the cost of the shares. Therefore, at operation 166, tax lot data can be uploaded to an appropriate tax lot data table, and subsequently, operations such as the aforementioned reconciliation of securities/positions/accounts, updating of tax lot data, etc. can be performed.

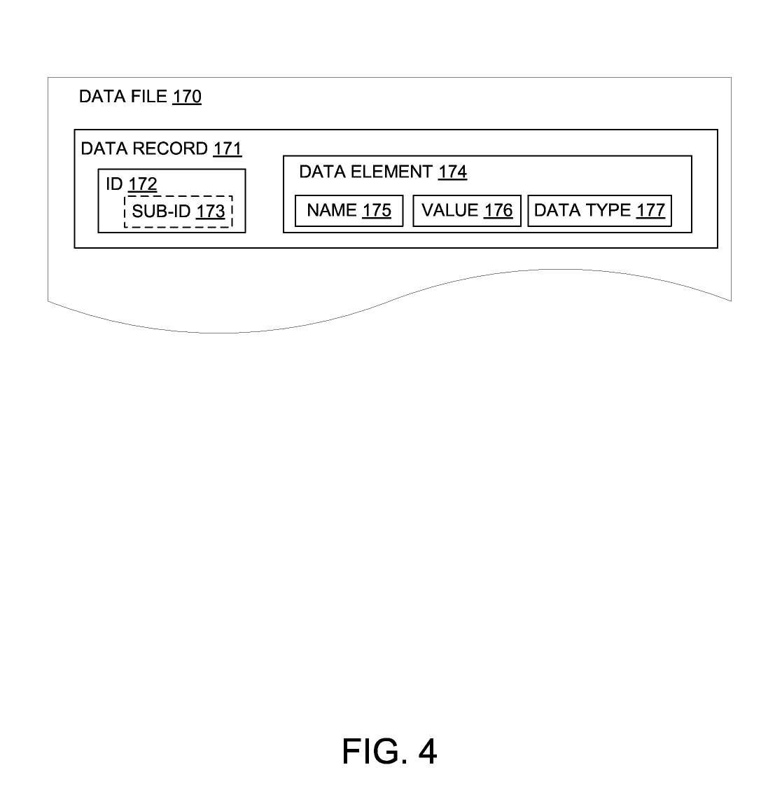

Positions data, tax lot data, trade data, etc. can be gleaned from one or more data files. Referring back to FIG. 1, security trading management system 102 may be configured to receive data 106 from at least one data source. Data 106 may be received in files of different formats (e.g., a PDF file, a .txt file, a .dat file, a .xml file, a .csv file, or a .xml file, etc. Referring now to FIG. 4, a data file 170 typically contains data related to a subject of interest to a user. For example, a subject may be a location weather, a hedge fund position, or a stock price, etc. The data file 170 may include at least one data record 171, each data record 172 corresponds to a particular instance of a subject, or contents of the data file 170 can be extracted into data records 171. Each data record 171 may include at least one ID 172 that identifies the instance of the subject, and at least one data element 174 that describes the instance of the subject.

Taking the hedge fund position (which can be a pool of underlying securities) as example, an instance of a hedge fund position can be uniquely identified by six pieces of information: the offering company, the accounting system, the particular account, the currency, the security, and its position (e.g., either long or short). Said differently, a hedge fund of a company holds a position based on the accounting system in a particular account in a particular currency for a certain security and its position is either long or short. Thus, an instance of a hedge fund position corresponds to a data record 171, which can be identified by an ID 172 including the CompanyID, DataSourceID, CustodianAccountID, CurrencyID, SecurityID, and Longshort collectively. Each of these IDs is a subsidiary ID 173.

For a particular instance of the subject, many data elements can describe it and these data elements are attributes of the subject. In the hedge fund position example, the quantity, the local price, the price book, the local cost, and the local market value are examples of attributes of a particular hedge fund position and can be used to describe the particular hedge fund position. In the described example, each data element 174 has a data element name 174, a data element value 176 and a data element data type 177. A data type is a classification identifying one of various types of data, such as, for example, floating point, integer or Boolean, which determines the possible value for that type.

The data storage system provides data to a user from the users 108A-D based on the user's requests. The requested data may be data files, data records, IDs, data elements, or in other formats of data. In some embodiments, the security trading management system 102 provides the requested data in a user-defined format.

Data such as that described above can be stored, accessed, linked, etc. as security trading management system 102 may be an agnostic data storage system and can store/process data records from various data sources, such as, e.g., counterparties 112A, accounting entities 112B, administrators 112C, and custodians 112D of FIG. 2. The agnostic data storage systems and methods have data structures that are more extensive over time and are capable of saving different source data of different data types or structures from different data sources. IDs and data elements of each data record are stored in a first data table and a second data table, respectively. Each second data table entry is linked to a first data table entry. For each data record, any number of data elements that describe the data record can be stored in the second data table. The second data table stores the name, the value, and the data type of each data element. Data structures for the second data table are defined without first knowing the name and the data type for data elements of each data record.

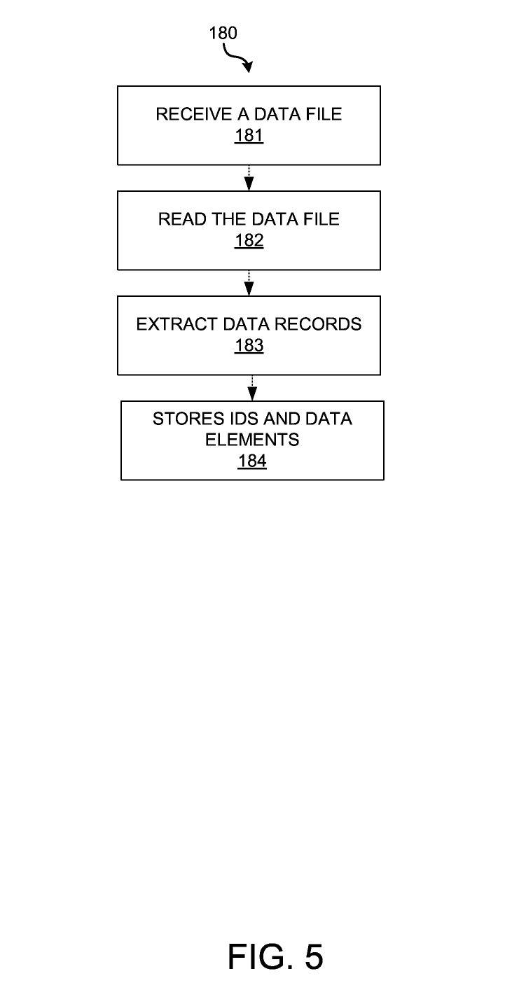

FIG. 5 illustrates an overview of an example adaptive data storage method 180 in accordance with one embodiment. At operation 181, the method receives a data file from a data source. The data source can be any source of data that may be of interest to the user using the data storage system such as, for example, the data sources 112A-112D or from one or more of the modules 116-122 of FIG. 2. The data file is related to a subject of interest to a user. The data file may include, for example, at least one data record, and, in some embodiments, each data record corresponds to a particular instance of a subject.

At operation 182, the method reads the data file. In one embodiment, the method creates and stores a server procedure, such as for example a SQL server procedure, and uses the stored server procedure to read the data file. At operation 183, the method extracts data records from the data file. Each data record includes at least one ID and at least one data element. At operation 184, the method stores the IDs and data elements of all data records. In one embodiment, the method stores the IDs and data elements into two data tables that are based on a key-value pair structure. IDs are stored in the first data table and data elements are stored in the second data table. Each first data table entry identifies a data record, and each second data table entry describes a data record. In one embodiment, each second data table entry is linked to a first data table entry, and each first data table entry may be linked to any number of second data table entries. The stored IDs and data elements can be retrieved in the future. In one embodiment, data records can be reformed and represented in a normalized-format from the retrieved IDs and data elements.

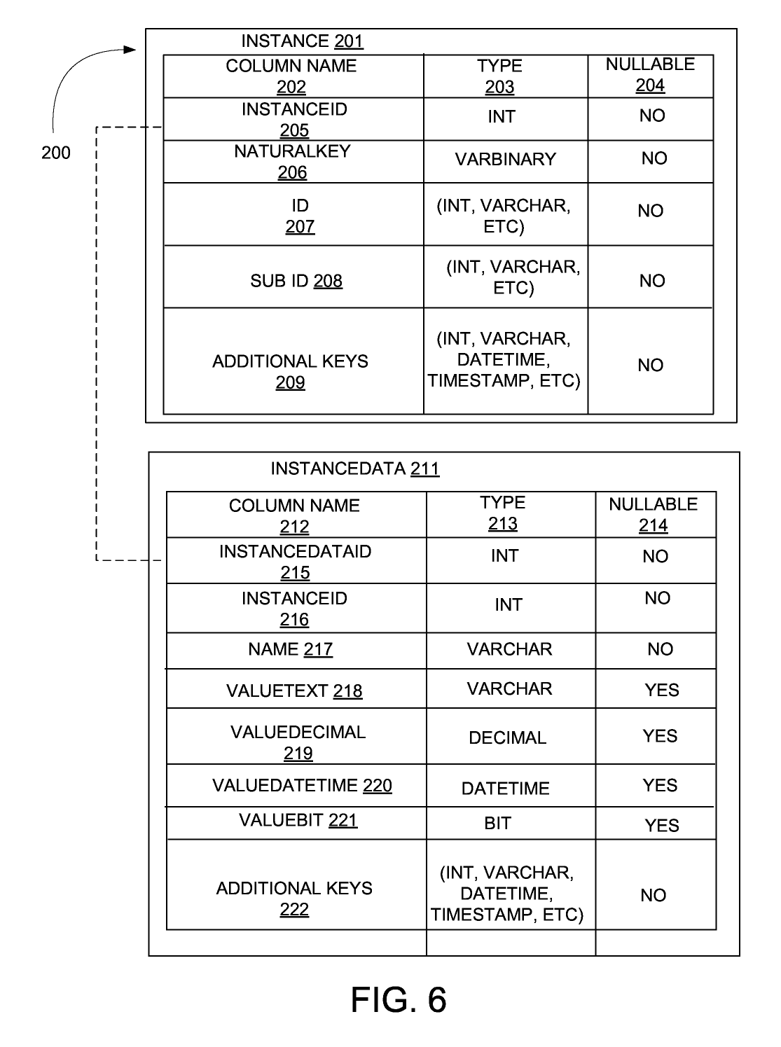

FIG. 6 illustrates data structures 200 for data tables 201 and 211 of an agnostic data storage system, which may be, e.g., data tables for storing tax lot data. In one embodiment, two data tables are used and data structures are defined respectively for each data table. The data table Instance 201 stores IDs. IDs for each instance of a subject are stored in a generic row of the data table Instance 201 as a data table entry. Each key defined in the data structure for the data table Instance 201 corresponds to a column of the data table Instance 201. An example data structure for this data table Instance 201 includes a key InstanceID 205. The key InstanceID 205 is unique to each row of the data table Instance 201.

Additionally, in one embodiment, an example data structure for the data table Instance 201 includes a key ID 207. The key ID 207 is an ID of a data record. In various embodiments, an additional key Subsidiary ID 208 is included in the example data structure for the data table Instance 201. In one embodiment, the example data structure for the data table Instance 201 includes a key NaturalKey. The example key NaturalKey is a logical key that has a logical relationship to all the IDs and subsidiary IDs and is unique to the instance of the subject. In some embodiments, various pieces of information that uniquely identify the instance of the subject are hashed into an example binary NaturalKey to aid in quick searching. In various embodiments, the data structure for the data table Instance 201 includes additional keys 209. The additional keys may be used for identification purposes or for other purposes. Examples of additional keys may include “Createdby,” “CreatedOn,” and “RowTimestamp.” In one embodiment, the data structure includes a Nullable column so that the user has control over whether to nullify a data entry in the data store when the column is not applicable. The data structure for the data table Instance 301 includes a definition of data type for each key. It will become apparent to one of ordinary skill in the art after reading this description that other keys (column names) and various data types can be used to define the data structure for Instance 201.

With further reference to FIG. 6, the data table InstanceData 211 stores data elements. Generally, a data element is an attribute of a subject, and a data element of a particular data record is an attribute of the particular instance of the subject. Attributes of each instance of a subject are stored in a generic row of the data table InstanceData 211. Each key defined in the data structure for the data table InstanceData 211 corresponds to a column of the data table InstanceData 211. An example data structure for this data table InstanceData 211 includes a key InstanceDataID 215 and a key InstanceID 216. The example key InstanceDataID 215 is unique to a row of the data table InstanceData 211, which is a data element that describes an instance of a subject. The example key InstanceDataID 215 is unique to that data element. In one embodiment, the InstanceID 205 and the InstanceDataID 215 link the data table Instance 301 with the data table InstanceData 211. All attributes of the particular instance of the subject can be stored in generic rows of the data table InstanceData 211 and these rows are linked to the corresponding row of the data table Instance 201. For each instance of the subject identified by and of which IDs are stored in a generic row of the data table Instance 201, any number of rows that are linked to this instance may be stored in the data table InstanceData 211. Accordingly, a user can store all data elements for any data record without deleting anything.

The data structure for the data table InstanceData 211 is defined such that the data table InstanceData 211 is agnostic to the name and the data type of a particular data element. In other words, for each data element, which is an attribute of a data record, the data structure for the data table InstanceData 211 can be defined without first knowing the name and the data type in order to store the data element. The data structure for the data table InstanceData 211 can be defined to include all relevant data types, and the data element is stored when the data type matches a defined data type. Illustrative examples of data types include character, variable character, decimal, bit, integer, short integer, long integer, floating point, double precision floating point, long double precision floating point, Boolean, list or array, two-dimensional array, alphanumeric strings, date, date-time, and all other data types. In one embodiment, an example data structure for the data table InstanceData 211 includes a key Name 217, a key ValueText 218, a key ValueDecimal 219, a key ValueDatetime 220, and a key ValueBit 221. In one embodiment, the key Name 217 is defined to be the data type variable character, the key ValueText 218 is defined to be the data type variable character, the key ValueDecimal 219 is defined to be the data type decimal, the key ValueDatetime 220 is defined to be the data type date-time, and the key ValueBit 221 is defined to be the data type bit. Other data types can be added as a key in the data structure for the data table InstanceData 211, then a corresponding column will be added to the data table InstanceData 211.

Still referring to FIG. 6, a data element is stored in the data table InstanceData 211 as a data table entry where the name of the data element is stored under the “Name” column and the value of the data element is stored under the column of which the data type matches the data type of the data element. For example, if a data element is a decimal number, then the value of the data element is stored under the “ValueDecimal” column. The entries under the other columns of which the data types do not match the data type of the data element will be nulled or flagged as not applicable. Data structure for the data table InstanceData 211 is not defined for storing a data element of a particular data type. Different data sources may name an attribute of a subject differently, but all these names for this particular attribute can be stored in the data table InstanceData 211. An attribute of a subject may have different data types, then all corresponding data elements having different data types can be stored in the data table InstanceData 211.

In various embodiments, the data structure for the data table Instance 211 includes additional keys 222. These additional keys may be used for identification purposes or for other purposes, such as to indicate the creator, to indicate the creation time, to show the time stamp. Illustrative examples of additional keys include “Createdby,” “CreatedOn,” “RowTimestamp,” etc. In one embodiment, the data structure includes a Nullable column so that the user has control over whether to nullify a data entry in the data store when the column is not applicable. The data structure for the data table Instance 211 includes data type definition for each key. It is apparent to one of ordinary skill in the art that other column names and data types can be used to define the data structure for InstanceData 211.

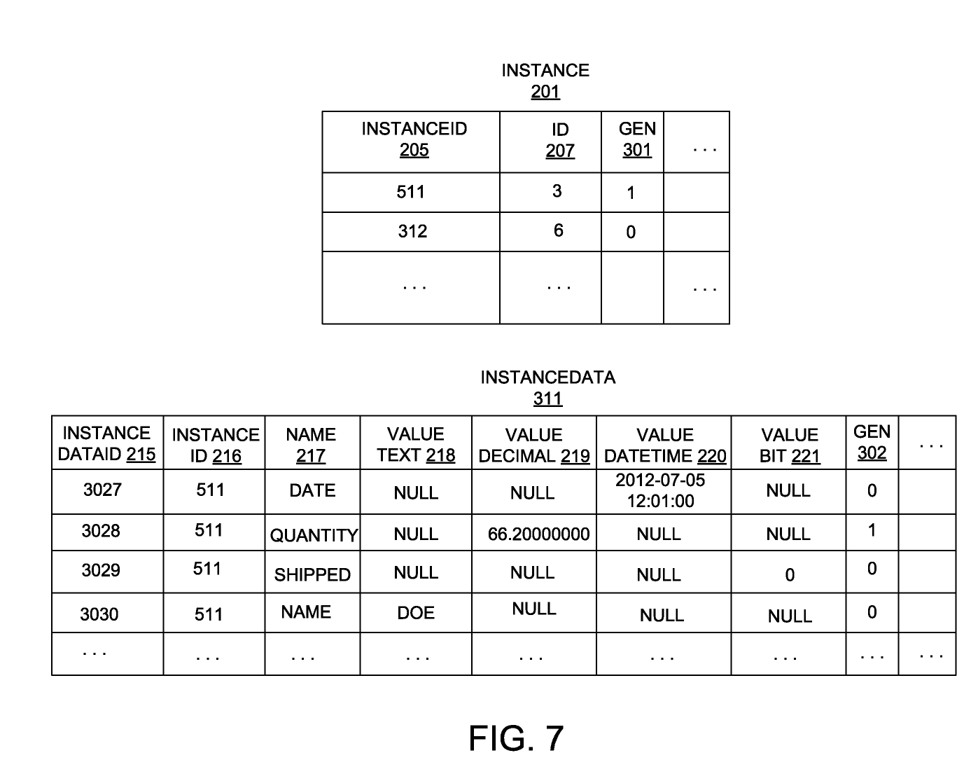

FIG. 7 illustrates data tables 201 and 211 described above. The data table Instance 201 stores IDs of data records. A row of the data table Instance 201 identifies an instance of a subject, which corresponds to a data record. For example, for the data record identified by the InstanceID 211, its ID 3 is stored as a data table entry. In one embodiment, additional IDs or subsidiary IDs of a data record can be stored as a data table entry. Thus, a data table entry includes one or more data table cells. A user can determine what ID or IDs, or what subsidiary ID or subsidiary IDs to be stored in the data table Instance 201. In one embodiment, the data table Instance 201 includes a Generation column 301 to show the generation of the particular data record. Each time when there is a change to the data record identification, the generation of the particular data element will increase by one (1).

The data table InstanceData 211 stores data elements of data records. A row of the data table InstanceData 211 is an attribute of the instance of the subject. For example, for the data record identified by the ID 511, its data element is stored as a data table entry in data table InstanceData 211. The data element name “Date” is stored under the example column Name 217. The data element value “2012-07-05 12:01:00” is stored under the example column ValueDatetime 220. Because this date element is of the data type Datetime, “Null” is stored under the example columns ValueText 218 ValueDecimal 219, and ValueBit 221 to show that the data types of these columns are not applicable to this data element. The names, values, and data types of four data elements are stored as data table entries for the example data record 211. A user can determine what information of a data element to be stored in the data table InstanceData 211. Additional columns of various data types can be added to the data table InstanceData 211 without overwriting the existing columns, so the user has the benefit of keeping all the data elements stored. Because no column needs to be deleted or changed in the data table InstanceData 211, data elements stored previously in the data table using an earlier data structure can still be stored and displayed in the data table with the current data structure.

Still referring to FIG. 7, in one embodiment, the data table InstanceData 211 includes a Generation column 302 to show generation of the particular data element. Each time when there is a change, the generation of the particular data element will increase by one (1). All the earlier generations of the data elements are stored in the data table.

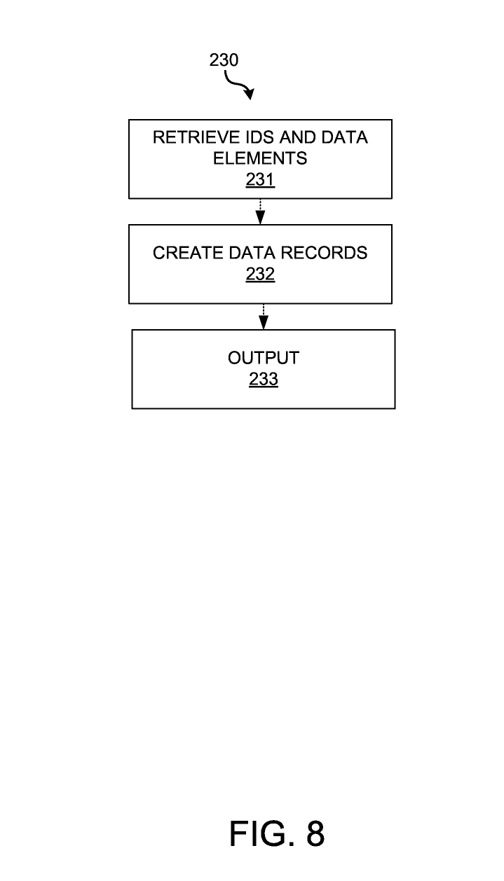

FIG. 8 illustrates an overview of an exemplary adaptive data storage method 230 in accordance with one embodiment. At operation 231, the method retrieves the stored IDs and data elements which may some relevant securities-related information as previously discussed. The fields of a data record that should be retrieved can be defined in accordance with data relationships relevant to securities, trades, positions, accounting, etc., and the method retrieves the IDs and data elements accordingly. At operation 232, the method creates data records by associating the IDs and the data elements. The created data records may be in a normalized format. At operation 233, the method returns the retrieved IDs and data elements in a format defined by the user. The format may be in a normalized data table, the method consolidates the retrieved IDs and data elements where the IDs and data elements are stored in different data tables. Or the method may output the IDs and data elements in separate user-defined data tables. In this manner, reconciliation can be accomplished across all entities, e.g., accounting entities, counterparties, administrators, etc. and bookkeeping can be kept accurate and up-to-date as any and all associated data can be properly maintained, accessed, and/or updated, deleted, or created as appropriate in accordance with securities management functions and operations.

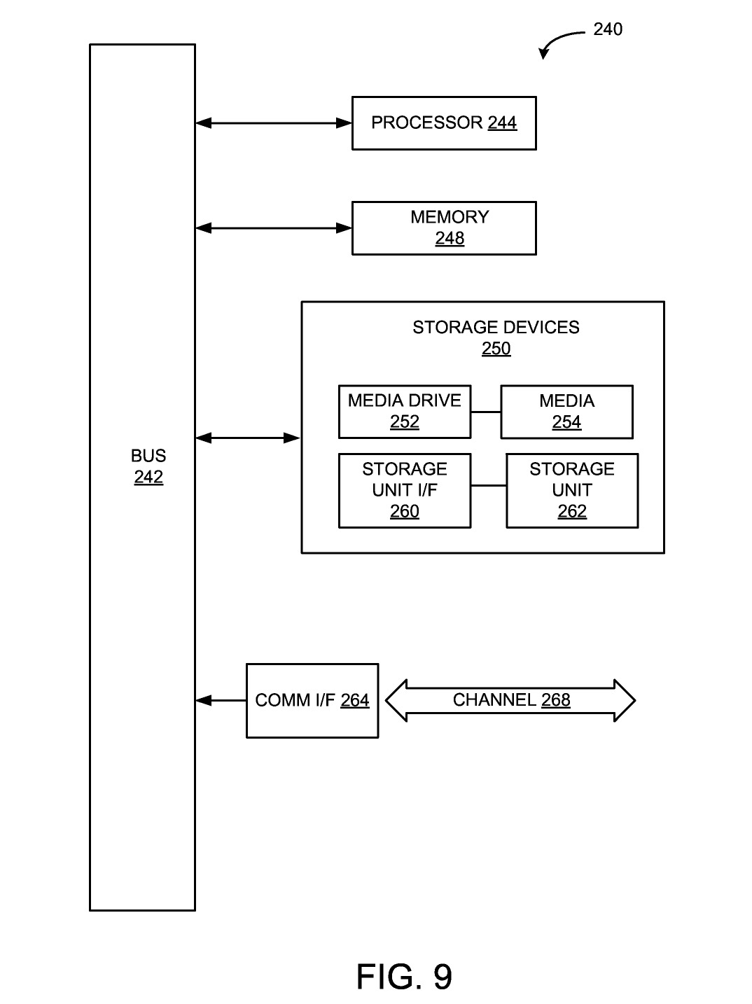

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 9. Various embodiments are described in terms of this example-computing module 240. After reading this description, it will become apparent to a person skilled in the relevant art how to implement the application using other computing modules or architectures.

FIG. 9 illustrates an example computing module 240, an example of which may be a processor for executing the business ecosystem tool used to implement various features and/or functionality of the systems and methods disclosed in the present disclosure. Computing module 240 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 240 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 240 might include, for example, one or more processors, controllers, control modules, or other processing devices, such as a processor 244. Processor 244 might be implemented using a general-purpose or special-purpose processing engine such as, for example, a microprocessor, controller, or other control logic. In the illustrated example, processor 244 is connected to a bus 242, although any communication medium can be used to facilitate interaction with other components of computing module 240 or to communicate externally.

Computing module 240 might also include one or more memory modules, simply referred to herein as main memory 248. For example, preferably random access memory (RAM) or other dynamic memory might be used for storing information and instructions to be executed by processor 244. Main memory 248 might also be used for storing temporary variables or other intermediate information during execution of instructions to be executed by processor 244. Computing module 240 might likewise include a read only memory (“ROM”) or other static storage device coupled to bus 242 for storing static information and instructions for processor 244.

The computing module 240 might also include one or more various forms of information storage devices 250, which might include, for example, a media drive 252 and a storage unit interface 260. The media drive 252 might include a drive or other mechanism to support fixed or removable storage media 254. For example, a hard disk drive, a floppy disk drive, a magnetic tape drive, an optical disk drive, a CD or DVD drive (R or RW), or other removable or fixed media drive might be provided. Accordingly, storage media 254 might include, for example, a hard disk, a floppy disk, magnetic tape, cartridge, optical disk, a CD or DVD, or other fixed or removable medium that is read by, written to or accessed by media drive 252. As these examples illustrate, the storage media 254 can include a computer usable storage medium having stored therein computer software or data.

In alternative embodiments, information storage devices 250 might include other similar instrumentalities for allowing computer programs or other instructions or data to be loaded into computing module 240. Such instrumentalities might include, for example, a fixed or removable storage unit 262 and an interface 260. Examples of such storage units 262 and interfaces 260 can include a program cartridge and cartridge interface, a removable memory (for example, a flash memory or other removable memory module) and memory slot, a PCMCIA slot and card, and other fixed or removable storage units 262 and interfaces 260 that allow software and data to be transferred from the storage unit 262 to computing module 240.

Computing module 240 might also include a communications interface 264. Communications interface 264 might be used to allow software and data to be transferred between computing module 240 and external devices. Examples of communications interface 264 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 264 might typically be carried on signals, which can be electronic, electromagnetic (which includes optical) or other signals capable of being exchanged by a given communications interface 264. These signals might be provided to communications interface 264 via a channel 268. This channel 268 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 248, storage unit 262, media 254, and channel 268. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 240 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A computer-implemented method, comprising:
obtaining a first set of trade data records at a first time point, each trade data record of the first set of trade data records comprising a first security and a first set of trading quantities associated with the first security;
storing the first security as a set of trade data table entries in a data store, the data store comprising the trade data table and a tax lot data table;
determining a first set of tax lots, from the tax lot data table, associated with the first security; and
storing each trading quantity of the first set of trading quantities in a corresponding trade data table entry.

2. The computer-implemented method of claim 1, further comprising determining each trading quantity of the first set of trading quantities based on the first security, an account, and a trading time.

3. The computer-implemented method of claim 1, further comprising determining each tax lot of the first set of tax lots based on the first security, an account, a position, and a date.

4. The computer-implemented method of claim 1, wherein each trading quantity of the first set of trading quantities correspond to a tax lot.

5. The computer-implemented method of claim 1, further comprising:
obtaining a set of tax lot data records at a second time point, each tax lot data record of the set of tax lot data records comprising a tax lot, a security, an account, a position, and a date; and
storing the set of tax lot data records in the data store, each tax lot data record of the set of tax lot data records corresponding to a tax lot data table entry.

6. The computer-implemented method of claim 5, wherein the step of
determining the first set of tax lots, from the tax lot data table, associated with the first security, comprising:
identifying a first set of accounts, a first set of positions, and a first set of dates associated with the first security from the trade data table; and
identifying a tax lot of the first set of tax lot corresponding to an account of the first set of accounts, a position of the first set of positions, and a date of the first set of dates.

7. The computer-implemented method of claim 5, wherein the first set of trade data records are obtained at a first time interval and the first set of tax lot data records are obtained at a second time interval longer than the first time interval.

8. The computer-implemented method of claim 1, further comprising analyzing the first set of trade data records and verifying the validity of the first set of trade data records to achieve reconciliation between one or more data sources or entities from which the first set of trade data records are obtained.

9. A system, comprising:
a processor; and
a memory storing instructions that, when executed by the processor, cause the system to perform:
obtaining a first set of trade data records at a first time point, each trade data record of the first set of trade data records comprising a first security and a first set of trading quantities associated with the first security;
storing the first security as a set of trade data table entries in a data store, the data store comprising the trade data table and a tax lot data table;
determining a first set of tax lots, from the tax lot data table, associated with the first security; and
storing each trading quantity of the first set of trading quantities in a corresponding trade data table entry.

10. A non-transitory computer-readable storage medium including instructions that, when executed by at least one processor of a computing system, cause the computing system to perform:
obtaining a first set of trade data records at a first time point, each trade data record of the first set of trade data records comprising a first security and a first set of trading quantities associated with the first security;
storing the first security as a set of trade data table entries in a data store, the data store comprising the trade data table and a tax lot data table;
determining a first set of tax lots, from the tax lot data table, associated with the first security; and
storing each trading quantity of the first set of trading quantities in a corresponding trade data table entry.
